(19) United States
(12) Patent Application Publication
(10) Pub. No.: US 2016/0110185 A1
(43) Pub. Date: Apr. 21, 2016

(54) INTEGRATING REDACT FUNCTIONALITIES IN APPLICATION DEVELOPMENT

(71) Applicant: Matthias Kienzle, Mannheim (DE)

(72) Inventor: Matthias Kienzle, Mannheim (DE)

(21) Appl. No.: 14/514,384

(22) Filed: Oct. 15, 2014

(51) Int. Cl. G06F 9/44; G06F 17/30

(52) U.S. Cl. CPC G06F 8/70; G06F 17/30339

(57) ABSTRACT

Various embodiments of systems and methods for integrating redact functionalities in software applications are described herein. In an aspect, the method includes receiving a request to register one or more sniffs related to an entity of the software application. The registration includes assigning a unique identifier and storing the registered stuff. Upon registration, one or more artifacts are accessed to perform operations including at least one of triggering redo and undo for the registered stuff based upon user's action, triggering done when a task related to the registered stuff is completed, assigning one or more information elements to the registered stuff, performing an operation including one of initialize, create, delete, done, and change corresponding to an information element, providing at least one of an action and data related to the performed operation, and handling an undo request and a redo request corresponding to the information element.

### BACKGROUND

Application development involves set of resources to develop, test, deploy, and troubleshoot software applications. During development, e.g., development with advanced business application programming (ABAP®), it is often required to redact (e.g., undo or redo) the actions to enable an application develop using the undo/redo functionality. However, there is no library which can be included into the development to offer “undo/redo” with a new or existing applications.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments may be best understood from the following detailed description taken in conjunction with the accompanying drawings.

FIG. 1 illustrates an exemplary DO_ENGINE and its associated artifacts to integrate redact functionalities in a software application, according to an embodiment.

FIG. 2 is a sequence diagram illustrating work controlled by a runtime entity, according to an embodiment.

FIG. 3 illustrates a central class of a DO_ENGINE along with its associated interfaces, database tables, and stacks, according to an embodiment.

FIG. 4 is a screenshot illustrating a toolbar including an undo icon and a redo icon displayed upon integration of a software application with a DO_ENGINE, according to an embodiment.

FIG. 5 illustrates interfaces, stacks, and classes associated with an “it,” according to an embodiment.

FIG. 6 is a sequence diagram for modifying and maintaining “it,” according to an embodiment.

FIG. 7 is a sequence diagram of “done,” according to an embodiment.

FIG. 8 is a sequence diagram for executing an “undo” request, according to an embodiment.

FIG. 9 is a sequence diagram for executing a “redo” request, according to an embodiment.

FIG. 10 is a sequence diagram for creating and modifying an object in a client-server roundtrip, according to an embodiment.

FIG. 11 is a sequence diagram for creating a plurality of objects in the client-server roundtrip, according to an embodiment.

FIG. 12 is a flow chart illustrating a process for executing the undo request, according to an embodiment.

FIG. 13 is a flow chart illustrating a process for executing the redo request, according to an embodiment.

FIG. 14 is a block diagram illustrating an exemplary computer system, according to an embodiment.

### DESCRIPTION

Embodiments of techniques for integrating redact functionalities in application development are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

“Central engine” refers to a unit which integrates redact functionalities (e.g., undo/redo) within software applications or projects. For integrating redact functionalities within a software application, the software application is integrated with the central engine. Different software applications or projects can be integrated with a central engine. In various embodiments, such an integration is enabled in advanced business application programming (ABAP®). Software applications or projects are implemented in ABAP® to enable integration with the central engine. The central engine may include various artifacts (e.g., various classes and interfaces) to enable integration with software applications and/or projects. The central engine may be referred to as “DO_ENGINE.”

“Runtime entity” or “entity” refers to an object having a state, a behavior, and an identity. Few examples of runtime entity include, but is not limited to, a controller, an interface, a navigator, a report, a class, an instance of a class, a function module, etc. A runtime entity may be a part of a software application or project. The runtime entity may traverse distinct functions such as delete, edit, create, etc. For example, the runtime entity “report” may traverse edit function with change of data within a report. The function is traversed based upon a user triggered action. For example, when a user deletes an address of a customer from a report then a delete function is traversed by the runtime entity “report.”

A software application may be integrated with the DO_ENGINE by integrating its runtime entity with the DO_ENGINE. Upon integration, a runtime entity takes control of the DO_ENGINE, e.g., starts or stops the DO_ENGINE. Once the DO_ENGINE is started, the runtime entity defines and registers its tasks with the DO_ENGINE. In an embodiment, there may be a separate dedicated runtime entity to control the DO_ENGINE and to decide when to start or stop the DO_ENGINE. The runtime entity which takes control of the DO_ENGINE may be referred as a supervisory runtime entity. For example, Floorplan Manager (FPM) application-specific configuration controller (AppCC), ABAP®, is an example of the supervisory runtime entity. The supervisory runtime entity may be communicatively coupled with other runtime entities registered with the DO_ENGINE to perform operations related to the project.

“Stuff” refers to a task or a purpose of the runtime entity. The stuff may be in form of a short description. A runtime entity defines one or more “stuffs” once integrated with the DO_ENGINE. The runtime entity registers its defined stuffs with the DO_ENGINE. A registered stuff is assigned a unique identifier (ID). The identifier may be textual, numerical, or alphanumerical. Once the stuffs are registered with the DO_ENGINE, the runtime entity gets access to the DO_ENGINE. In various embodiments, the registered stuff may be referred as “do.”

“Do_interface” refers to an integration interface of a DO_ENGINE though which integration with the DO_ENGINE takes place. For example, a runtime entity registers its stuffs to the DO_ENGINE through the do_interface. The do_interface includes a function (e.g., it( ) though which the runtime entity registers or integrates its stuffs to the DO_ENGINE.

“It” refers to information element of a registered stuff (“do”). Each registered stuff (“do”) is associated with at least one “it.” For example, a “do” responsible for address may has a single “it” representing address information while a “do” responsible for central data comprising name and classification may have two “it”: one “it” representing name data and another “it” representing classification data. “It” may undergo modification by user's actions like create, change, delete, etc. Therefore, an “it” may also represent one or more tasks which “it” go through based upon user's action. The tasks which “it” goes through form base of any redo/undo operation. “Task” refers to an action and data representing a modification in “it.” The task gets stored in a ‘task_stack’ according to their occurrence sequence.

“Stack” refers to a data structure that allows addition and removal of data in a particular order. When data is added, it goes on the top of the stack. The data that can be removed is the data that is at the top of the stack. Therefore, the stack is of type “first in, last out” or “last-in, first-out” (LIFO). The first item added to the slack will be the last item removed from the stack. Addition of data to the stack refers to “pushing data to the stack” and removal of data from the stack refers to “popping data from the stack.” With a modification of a runtime entity or “it,” a new task is created and pushed to a “task_stack” which allows navigating back and forth through the slack levels to perform undo/redo function. The task to be undone or redone is handed aver to relevant “how-to” implementation.

“How-to” or “how” refers to an access interface to perform undo and/or redo. Each “do” has one or more “it” and each “it” has a “how-to.” A “how-to” explains how an action associated with “it” can be undone/redone. Therefore, the “how-to” is referred when there is a request for undo/redo. The “how-to” may refer to the “task_stack” to perform undo/redo when requested.

“Work” refers to an operation by which the runtime entity controls functions related to the DO_ENGINE, e.g., when to start the “DO_ENGINE,” when to trigger request for undo/redo, and when to trigger “done,” etc. “Done” may refer to completion of a client-server round trip. The DO_ENGINE may include an “IF_DO_WORK” interface to indicate whether the work related to “do” is started, done, or break. The “IF_DO_WORK” interface may also indicate whether there is request for undoing/redoing an action related to the “do” and whether the action is undoable/re-doable. In an embodiment, the DO_ENGINE also includes an “IF_DO_IT_WORK” interface related to “it.” The “IF_DO_IT_WORK” interface is accessed when there is a request for undoing/redoing an action related to the “it.” The “IF_DO_IT_WORK” interface indicates what to undo/redo related to “it.”

“Artifact” as used herein refers to one or more components of the DO_ENGINE. Artifact includes, but is not limited to, at least one of one or more classes and one or more interfaces involved in performing operations related to the DO_ENGINE.

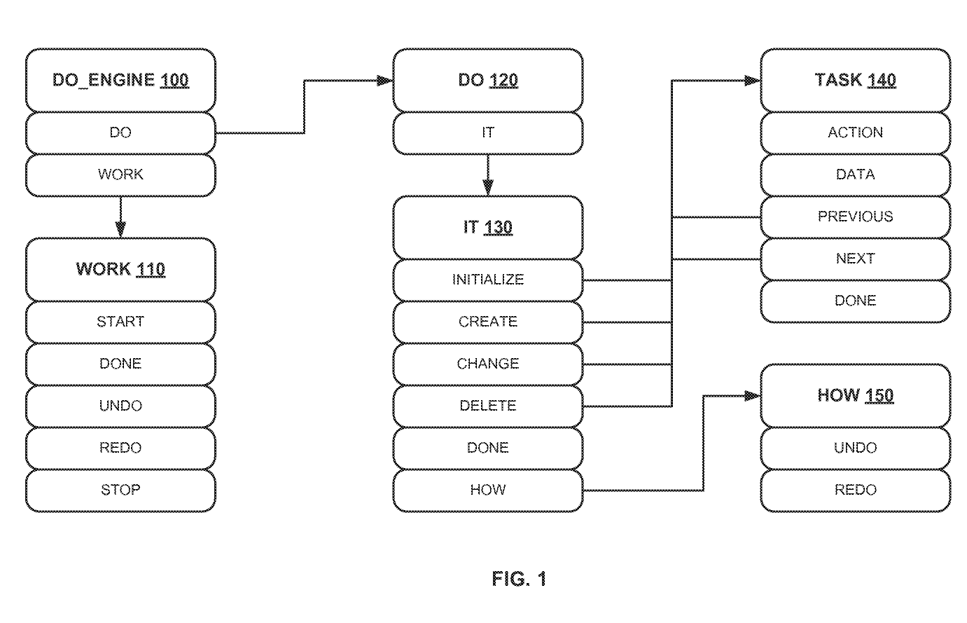

FIG. 1 is a block diagram illustrating exemplary “DO_ENGINE” 100 and its associated artifacts WORK 110, DO 120, IT 130, TASK 140, and HOW 150 for integrating redact functionalities within a software application or project (not shown). In an embodiment, artifact WORK 110 may be referred as work_artifact, DO 120 may be referred as do_artifact, IT 130 may be referred as it_artifact, TASK 140 may be referred as task_artifact, and HOW 150 may be reffered as how_artifact. In an embodiment, integrating refers to one of setting-up, launching, deploying, and configuring. The redact functionalities include, but is not limited to, undo operation and redo operation. The redact functionalities can be integrated within the software application by integrating the software application with the DO_ENGINE 100. In an embodiment, the software application is integrated with the DO_ENGINE 100 by integrating its one or more runtime entities with the DO_ENGINE 100. A runtime entity may be one of a controller, an interface, a navigator, a report, a class, an instance of a class, and a function module, etc. In an embodiment, the integration is enabled when the runtime entity requests control of the DO_ENGINE 100 by calling a function (e.g., work( )) of the DO_ENGINE 100. Upon receiving control, the runtime entity can access WORK 110. The WORK 110 includes at least one of one or more interfaces and classes to enable the runtime entity to control the DO_ENGINE 100, e.g., start and stop the DO_ENGINE 100 and trigger done, redo, undo, etc. Upon receiving the control of the DO_ENGINE 100, the runtime entity may start the DO_ENGINE 100.

Once the DO_ENGINE 100 is started, the runtime entity defines its “stuffs.” A “stuff” may be a short description defining a purpose or a task of the runtime entity. The runtime entity may define its stuffs dynamically at runtime. The runtime entity registers its defined stuffs with the “DO_ENGINE” 100. A registered stuff may he referred as “do.” The DO_ENGINE 100 assigns a unique identifier (ID) to the registered stuff or “do.” In an embodiment, the registered stuffs are stored in GT_DOS (not shown). In an embodiment, the GT_DOS is a member of a central class of the “DO_ENGINE” 100. The GT_DOS includes at least two columns of which a first column contains the stuff IDs of respective registered stuff or “do” and a second column includes a reference to an instance of the CL_DO class by access interface IF_DO. The “DO_ENGINE” 100 may identify the registered stuffs (“do”) through the GT_DOS.

The registered stuffs may be controlled through DO 120. The DO 120 may include at least one of one or more interfaces and one or more classes for controlling operations related to the registered stuff (“do”). Each registered stuff or “do” has at least one “it” to represent one or more tasks which the “do” undergoes. The task includes an action and data. The IT 130 offers various methods (e.g., change, create, delete, and initialize, etc.) to perform task corresponding to user's actions. The IT 130 comprises at least one of one or more interfaces and. one or more classes for handling an “it.” In an embodiment, a task related to “it” is maintained by the artifact TASK 140. The TASK 140 indicates the action performed on “it” and/or data related to that action. The task is stored in a “task_stack.”

The IT 130 is also associated with HOW 150 to show how an undo/redo can be performed relative to an “it.” When an undo/redo is requested for an “it,” the DO_ENGINE 100 refers to the HOW 150 of the “it” to perform the requested change. When the undo is requested for an “it,” the HOW 150 identifies one or more tasks previously performed from the “task_stack” of the “it” and then the identified one or more tasks are undone, e.g., canceled/deleted. Similarly, the redo request can be handled by the HOW 150 of the DO_ENGINE 100.

The DO_ENGINE 100 can configure the redact functionalities within the software application. For integrating redact functionalities within the software application, the software application is integrated with the DO_ENGINE 100. The software application may be integrated through its runtime entity. For integration, the runtime entity is registered with the DO_ENGINE. The runtime entity may be registered by requesting control of the DO_ENGINE 100. Upon taking control, the runtime entity can start the DO_ENGINE 100, define its stuffs, and register its defined stuff to the DO_ENGINE 100. In an embodiment, there may be a separate dedicated runtime entity to control the DO_ENGINE 100 and decide when to start or stop the DO_ENGINE 100. The runtime entity which lakes control of the DO_ENGINE 100 may be referred as a supervisory runtime entity. The supervisory runtime entity may be communicatively coupled to other runtime entities registered with the DO_ENGINE 100 to define and register its stuffs for performing operations related to the software application. Based upon the performed operation, the supervisory runtime entity can trigger done, undo, redo, etc. The supervisory runtime entity takes decision based upon the user's action.

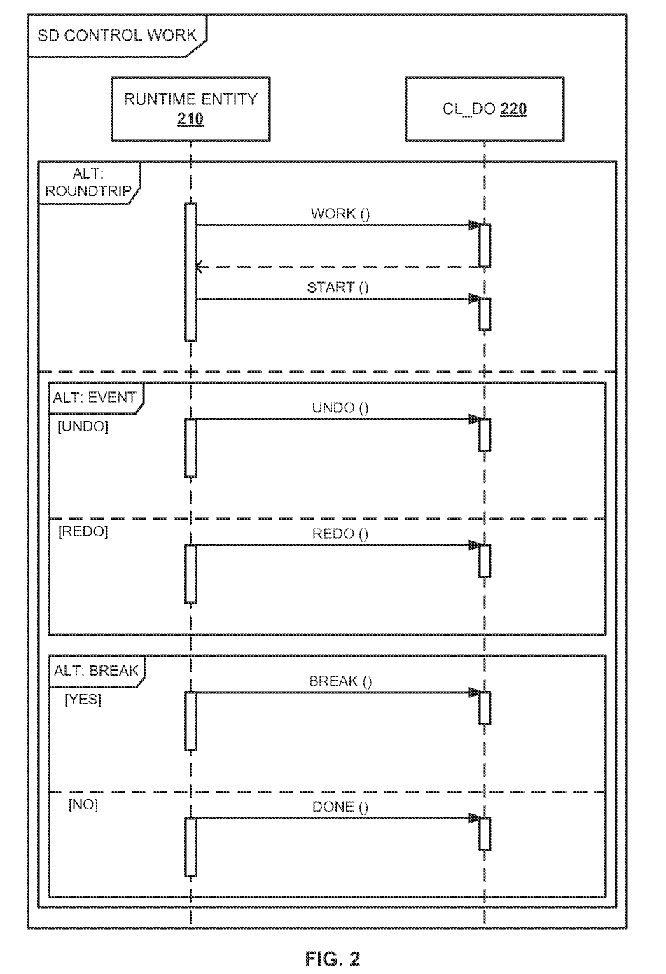

FIG. 2 is a sequence diagram showing work controlled by a supervisory runtime entity 210. The supervisory runtime entity 210 request control of the DO_ENGINE (e.g., DO_ENGINE 100 as illustrated in FIG. 1), e.g., by calling a function work( ), of a central class CL_DO 220. Through function work( ), the supervisory runtime entity 210 can access WORK 110 and get control of the DO_ENGINE 100 (FIG. 1). Upon getting control, the supervisory runtime entity 210 can call a function start( ) of the WORK 110 to start the DO_ENGINE 100. Once the DO_ENGINE 100 is started, the supervisory runtime entity 210 can handle event like undo/redo by calling functions undo( )and redo( ), respectively, of WORK 110 based upon the user's action. In case a user cancels or ends an user interface (UI) session in-between, the supervisory runtime entity 210 may trigger a function break( ) of WORK 110. in case the request is executed successfully, the supervisory runtime entity 210 may trigger a function done( ) of the WORK 110 to indicate the completion of the task. In an embodiment, done( ) is the indication that all tasks of all its are done. Therefore, the supervisory runtime entity 210 can control the work related to the DO_ENGINE 100, and decide when to start or stop the DO_ENGINE 100 and when to trigger redo, undo, done, and break.

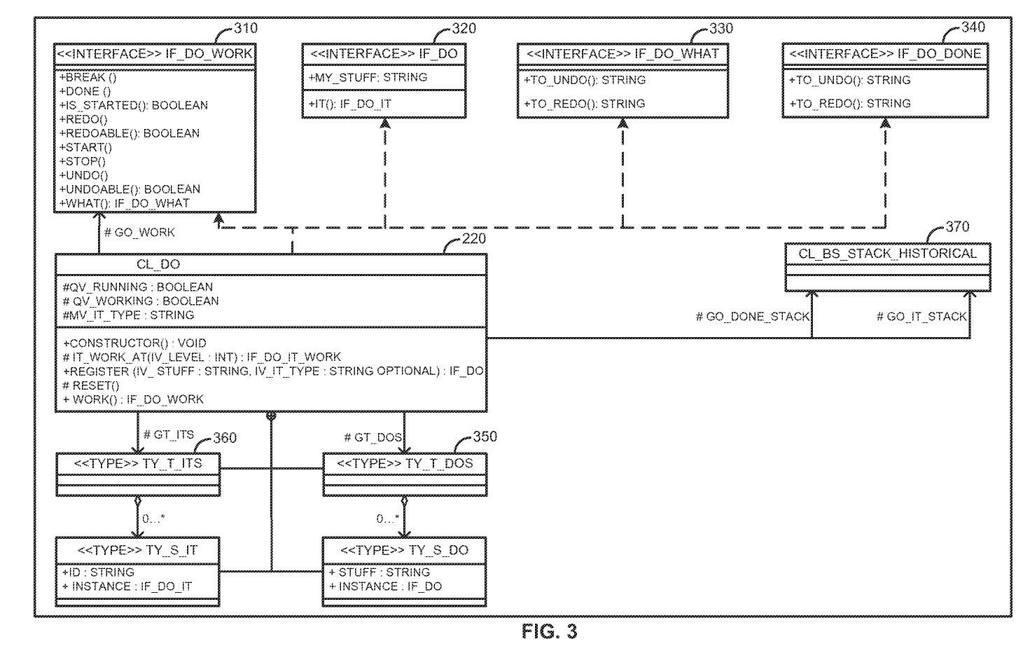

FIG. 3 illustrates a central class CL_DO 220 and its associated interfaces 310-340, database tables 350-360, and stack 370, according to an exemplarily embodiment. “CL” indicates “class.” The central class CL_DO 220 implements several access interfaces. In an embodiment, the interfaces include, but are not limited to, IF_DO_WORK 310, IF_DO 320, IF_DO_WHAT 330, and IF_DO_DONE 340. “IF” indicates “interface.” The interfaces 310-340 may be accessed by calling an appropriate function or method of the central class CL_DO 220. For example, IF_DO_WORK 310 interface may be accessed by calling a function work( ) of the central class CL_DO 220, In an embodiment, IF_DO_WORK 310 may be an interface of the artifact WORK 110, whereas IF_DO 320, IF_DO_WHAT 330, and IF_DO_DONE 340 may be the interfaces of the artifact DO 120. In an embodiment, a function It( ) of the interface IF_DO_DONE 340 is being called by each “It” to indicate that a single task it went through is done. This is a “back-communication” from “It” back to the central class of the DO_ENGINE, to the “Do” of this “It”. By this that “It” gets pushed to an IT_STACK. Therefore, IF_DO_DONE 340 is an interface through which the “It” artifact accesses the “Do” artifact to report on finishing a “Task” artifact.

Through the IF_DO_WORK 310 the runtime entity can control when to start and stop the DO_ENGINE 100, when to trigger break, redo, undo, and what to undo/redo. The IF_DO_WORK 310 accesses IF_DO_WHAT 330 to identify what to undo/redo when undo/redo is requested by the user. Once the work is completed, it is reported through the supervisory entity's call of done( ) of the IF_DO_WORK 310 whereas IF_DO_DONE 340 reports on whether a task of an “It” is done. Similarly, the runtime entity can access the interface IF_DO 320 to register its stuffs to the DO_ENGINE 100 by calling a method register( ) of the central class CL_DO 220. The stuff is registered as “do” and all registered stuffs are collected or stored in the GT_DOS 350. The central class CL_DO 220 and its associated interfaces 310-340, therefore, helps the runtime entity to get integrated to the DO_ENGINE 100 to control the DO_ENGINE 100, e.g., start the DO_ENGINE 100.

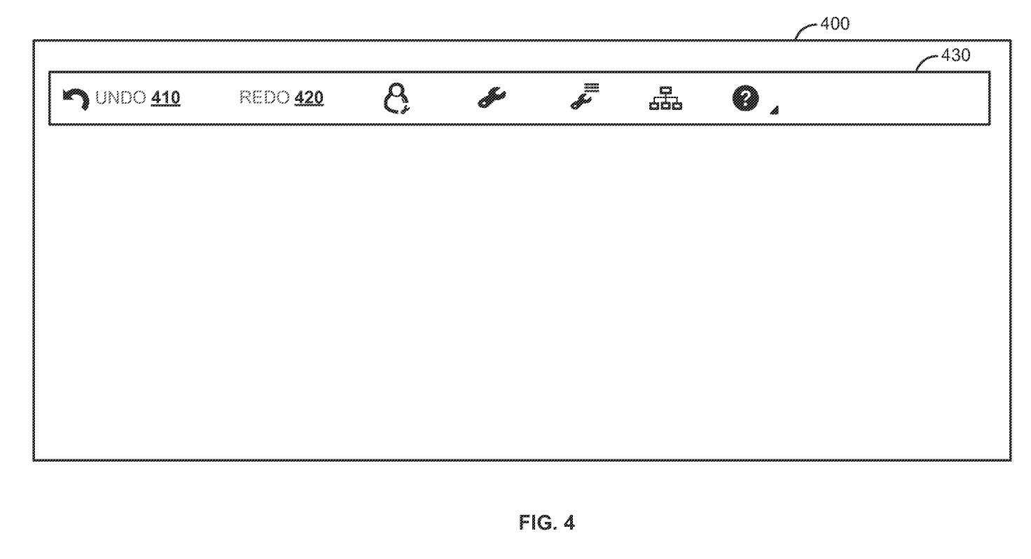

Once the DO_ENGINE 100 is started, the runtime entity can define and register its stuffs with the DO_ENGINE 100. The stuff refers to the purpose or task of the runtime entity and it may be in form of a short description. The runtime entity registers its stuffs by calling the function register( ) of the central class CL_DO 220. Once the stuffs are registered, the runtime entity gets integrated to the DO_ENGINE 100. FIG. 4 shows “undo” icon 410 and “redo” icon 420 which appears on a user interface (UI) 400 of a global toolbar 430 of a project once the runtime entity of the project is integrated with the DO_ENGINE 100. The undo icon 410 and the redo icon 420 are active when their action is available. Therefore, the “undo” icon 410 and the “redo” icon 420 is not active upon launching the application or project. Working within the application or project switches the “undo” icon 410 active and once the “undo” icon 410 is selected, the “redo” icon 420 also gets activated.

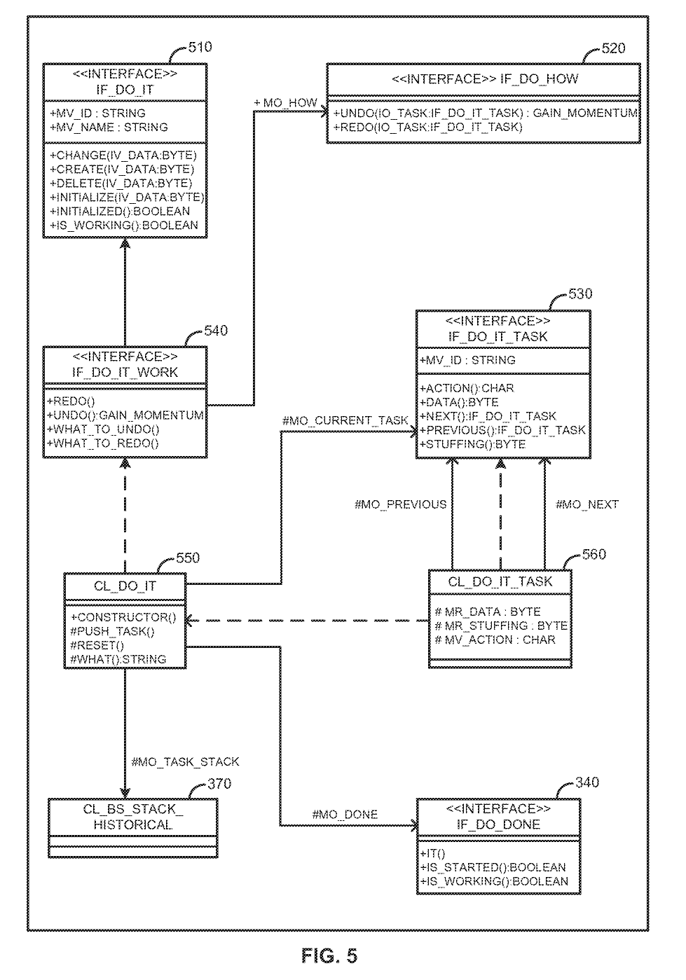

While registering its stuffs, the runtime entity provides assignation of “it” to its stuff. The runtime entity provides assignation of “it” to its registered stuff (“do”) through the IF_DO 320. The IF_DO 320 includes the unique ID of “do” and a function it( ) to assign “it” to respective “do.” One or more “it” corresponding to a “do” is stored in GT_ITS 360 (FIG. 3) a member of the central class CL_DO. By assigning “it” to “do,” the runtime entity gets access to an interface IF_DO_IT 510 (FIG. 5). FIG. 5 shows various interfaces, stacks, and classes associated with an “it.” The IF_DO_IT 510 receives information on which modifications can be done to an “it,” The IF_DO_IT 510 includes functions such as change, create, delete, initialize, etc., to perform modifications or task on the “it” and receive information related to the task. A function indicates the action to modify “it” and/or data related to the action to indicate what happened to “it.” For example, the runtime entity (e.g., data model API), responsible to “report modifications done to its data” (i.e., “it”) calls function change( ) of IF_DO_IT 510 whenever a change of data is requested and calls delete( ) when a data record is deleted.

The runtime entity may be responsible to report modifications done to its data or “it.” The modification may be done based upon user's action. Based upon the user's action, the runtime entity calls appropriate function of an interface IF_DO_IT 510. For example, if a data is changed, a function change( ) of IF_DO_IT 510 is called and if a data record is created then a function create( ) of IF_DO_IT 510 is called. Based upon the user's action, the runtime entity decides if and what data to hand over for required change/create action, The modification along with data is hand over to “how” implementation which enable to perform redo/undo later, if requested. While assigning “it” to its “do” the runtime entity also specify “how” through an interface IF_DO_HOW 520 (FIG. 5). “It” decides what data “it” hands over to allow “how” implementation to redo/undo the task if requested later.

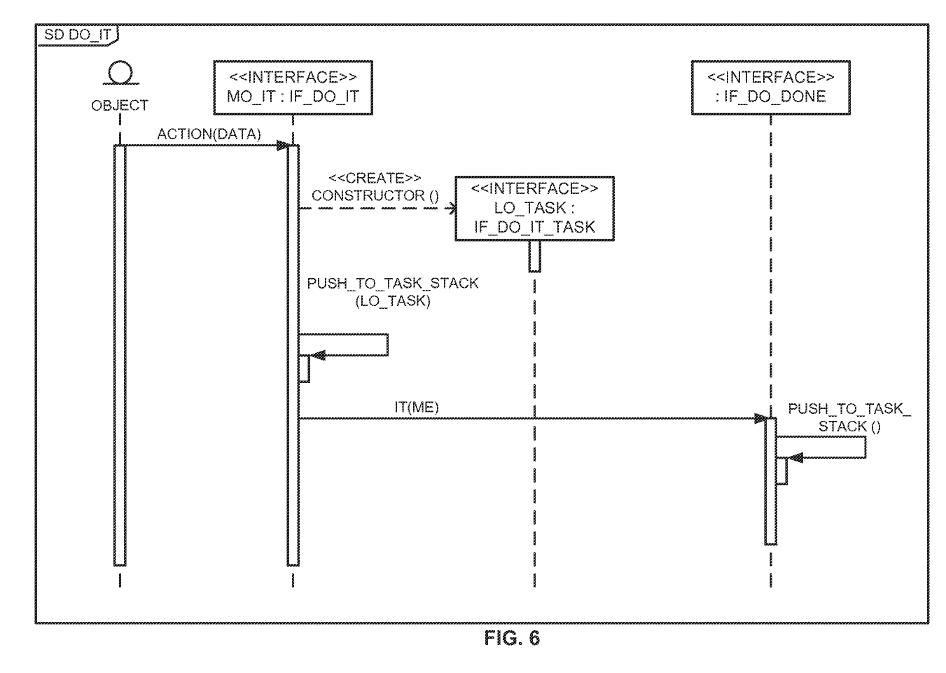

With a modification of “it,” a new task is created and pushed to the “task_stack.” “It” pushes a newly created task to its “task_stack” as soon as a method like change( ) or create( ) has been called. The task contains its “action” (create, change etc.) along with arbitrary data/information handed over during call of method change( ), create( ) etc. The IF_DO_IT_TASK 530 represents a task that is being pushed to the task stack. Once the task is pushed, “it” reports itself to an interface IF_DO_DONE 340. FIG. 6 is a sequence diagram showing modification of “it” and maintaining modified “it” in a “done_stack.” Based upon user's action (e.g., create, delete, or modify), the action and corresponding data is handed to the interface IF_DO_IT 510. Once the action and data is recorded in the interface IF_DO_IT 510, the runtime entity accesses the interface IF_DO_IT TASK 530, e.g., using a function “constructor ( ).”

The task corresponding to the action and data is created and pushed to the “task_stack.” The “task_stack” includes action and data corresponding to the action. The “task_stack” is stored with respective “it.” The stored tasks within the task_stack are the tasks which are performed or executed on the “it.” Once the task is executed, the “it” is modified. Upon completion of the task, the “it” reports the interface IF_DO_DONE 340 to alert that the task is done and the modified “it” is pushed to an “it_stack” (not shown). Therefore, “it” experienced modification by its “do” pushed to “it_stack” of the CL_DO 220. The “it_stack” is stored within the CL_DO 220. The interface IF_DO_DONE 340 pushes “it_stack” to a “done_stack.” After pushing “it_stack” to the “done_stack, the interface IF_DO_DONE 340 provides a new “it_stack” where a newly modified “it” can be pushed again. In an embodiment, the it_stack and done_stack may be maintained as historical stack 370 namely CL_BS_STACK_HISTORICAL (FIG. 3) which can be referred for undoing/redoing a task.

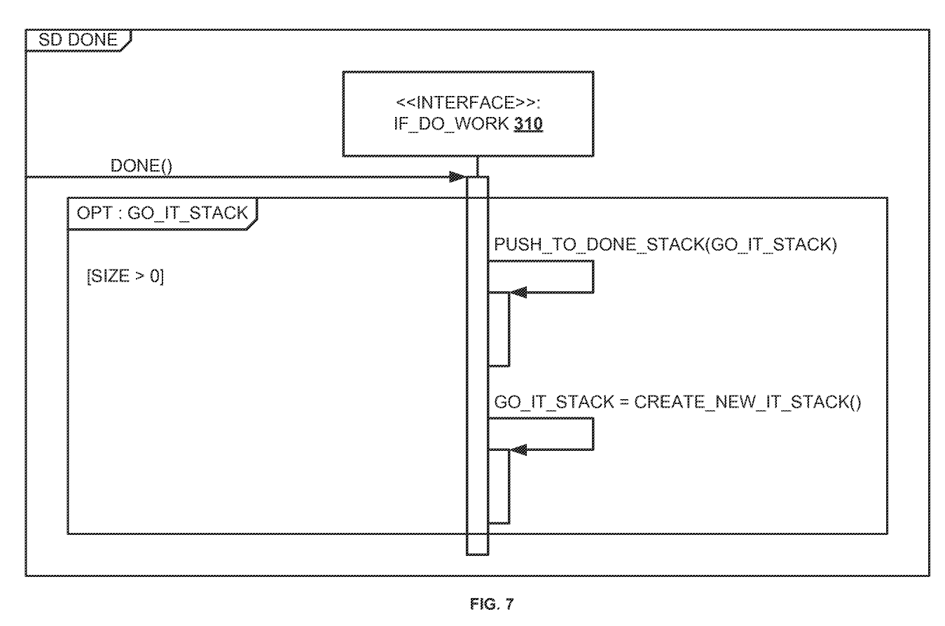

FIG. 7 is a sequence diagram of “done.” When a “done” is triggered through the interface IF_DO_WORK 310, the “it_stack” (shown as go_it_stack) is pushed to “done_stack” (shown as done_{—.}stack). The it_stack is pushed to the done_stack by calling: push_to done stack(go_it_stack). The “it_stack” is pushed to the done_stack until its data size is greater than 0 (i.e., size>0), Once the “it_stack” is pushed to “done_stack,” a new “it_stack” is created by calling: go_it_stack=create new_it_stack( ). In the new “it_stack,” the newly modified “it” can be pushed again.

Upon receiving undo/redo request, the runtime entity access the IF_DO_WORK 310 (FIG. 3). In an embodiment, the IF_DO_WORK 310 is accessed through the function work( ) of the central class CL_DO 220. Through the IF_DO_WORK 310, the runtime entity can control (e.g., start and stop) the DO_ENGINE 100, execute the request for undoing/redoing an action related to the “do”, determine whether the action is undoable/redo-able, determine what to undo/redo, and trigger break or done. In an embodiment, when an undo/redo is requested related to an “it,” the work interface related to “it,” e.g., IF_DO_IT_WORK 540, is accessed. The IF_DO_IT_WORK 540 control undo/redo request corresponding to “it” and describes what to undo/redo. The IF_DO_IT_WORK 540 communicates with IF_DO_HOW 520 to refer how to undo/redo. The IF_DO_HOW 520 includes reference to IF_DO_IT_TASK 530. The IF_DO_IT_TASK 530 includes information on task (e.g., action and data) which is executed. The IF_DO_IT_TASK 530 is communicatively coupled to a class CL_DO_IT 550 to receive information on which task is to be performed. In an embodiment, a task class CL_DO_IT_TASK 560 is coupled to the interface IF_DO_IT_TASK 530 to indicate a type of action and data acceptable for the task. Undo/redo can be performed through IF_DO_IT_TASK 530 using the “task_stack.”

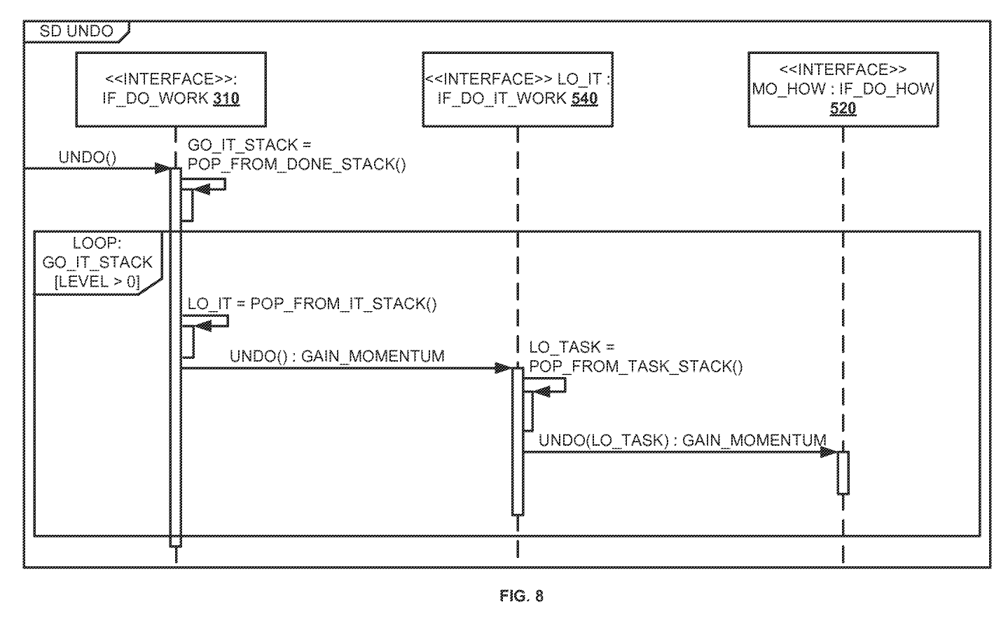

FIG. 8 is a sequence diagram for executing an undo request, according to an exemplarily embodiment. When a request for undo is received for a “do,” the IF_DO_WORK 310 (FIG. 3) is accessed to perform undo. For undoing, an “it_stack” is popped from the “done_stack” (i.e., GO_IT_STACK=POP_FROM_DONE_STACK( )). As the “done_stack” includes all the “it” of the “do” which are modified, therefore, the created new it_stack also includes all the modified “it” in LIFO format. Once the new “it_stack” is created, the IF_DO_IT_WORK 540 is accessed to perform undo for each “it” of the new “it_stack” until all “it” from the “it_stack” is covered (loop: go_to_stack (level>0)). Each “it” from the “it_stack” is popped one by one (e.g., using LO_IT=POP_FROM_IT_STACK( ); LO represents loop) and the task_stack of the popped “it” is identified. The task_stack includes all executed tasks of the popped “it.” A task is popped from the task_stack (e.g., using LO_TASK=POP_FROM_TASK_STACK( ) and canceled or undone, e.g., using UNDO(LO_TASK) through IF_DO_HOW 520. Therefore, if an “It” was modified multiple times during one client-server roundtrip (or one supervisory done) it pushed each related task to its task stack and afterwards itself to the “it_stack.” An “It” that experienced multiple changes for instance is pushed multiple times to the same it stack. If this it_stack is being popped from this “it” appears multiple times as well and is being asked to undo the upmost task of its task stack.

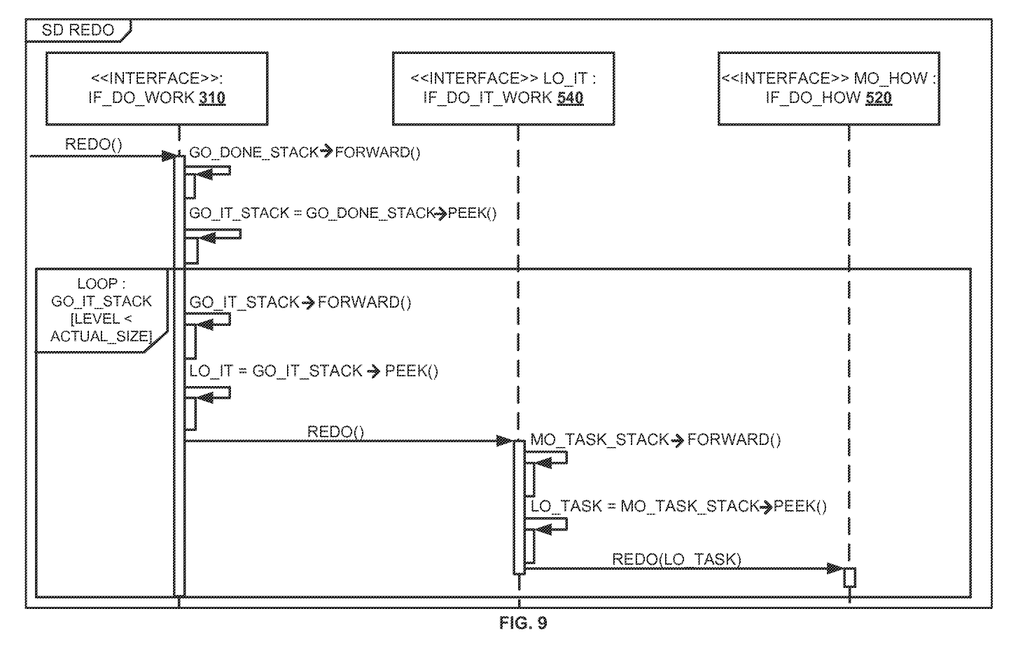

FIG. 9 is a sequence diagram for executing a redo request, according to an exemplarily embodiment. When a request for redo is received relative to a “do,” the IF_DO_WORK 310 (FIG. 3) is accessed to perform redo. For redoing, a forward operation (forward( )) is triggered to raise the “done_stack” level by one (i.e., GO_DONE_STACK->FORWARD( )). Next, one “it_stack” is peeked from the “done_stack” (i.e., GO_IT_STACK=GO_DONE_STACK->PEEK). Now, a loop is executed at the it stack is processed by calling forward( ) (e.g., GO_IT_STACK->FORWARD( )) and raising redo( )for each resulting “it,” one after the other until the it_stack level is at top level (i.e., LOOP: GO_IT_STACK[LEVEL<ACTUAL SIZE]). Similarly, the task_stack is processed by calling forward( ) (e.g., i.e., MO_TASK_STACK->FORWARD( )). For each redo( ) triggered to the “it” of the it_stack, one task is popped from the task_stack of that “it” (i.e., LO_TASK=MO_TASK_STACK->PEEK( )) and requested to redo (i.e., REDO(LO_TASK)).

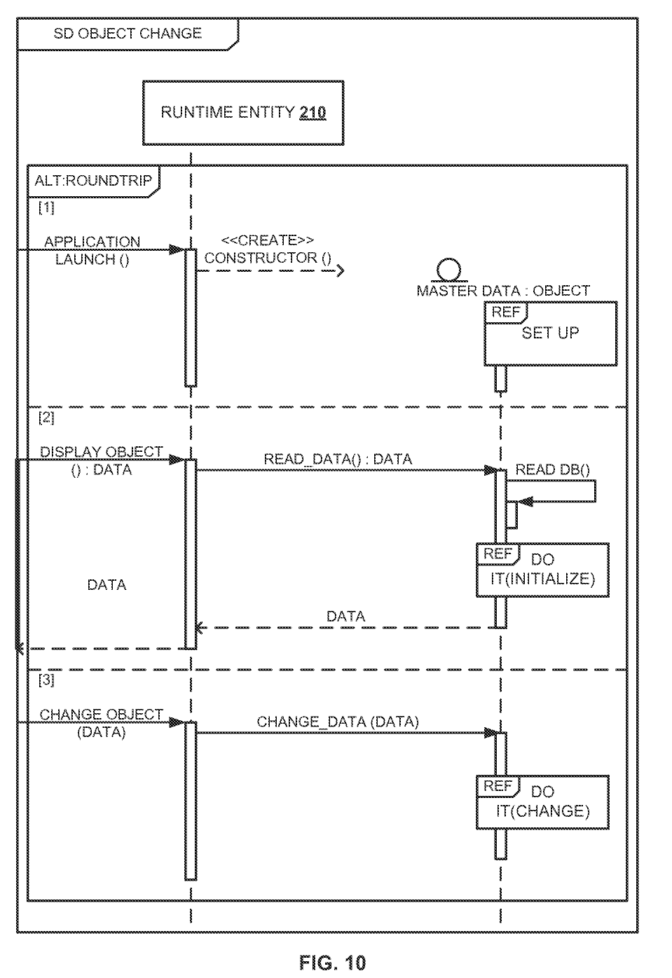

FIG. 10 is a sequence diagram to define (create) and modify an object (stuff) in a client-server round trip, according to an embodiment. Once the software application is launched, the runtime entity creates or defines (e.g., through a function constructor( )) the object (stuff) such as a user's address. The stuff is set up (registered) as “do.” The data related to the registered stuff may be displayed (displayObject( ): data), read (read_data( ): data), and stored in a database (DB). The data may be initialize as “it” of corresponding “do” through a function initialize( ) of interface IF_DO_IT.” The data can be changed using changeObject(data) and change_data(data). The changed data corresponds to changed “it” and is notified as (do it(change)). In an embodiment, a function “do_it” is not a function of any of the interfaces or classes but rather a synonym for all the actions of a task, like create_id resulting in it-create( ) or change_it resulting in it-change( ).

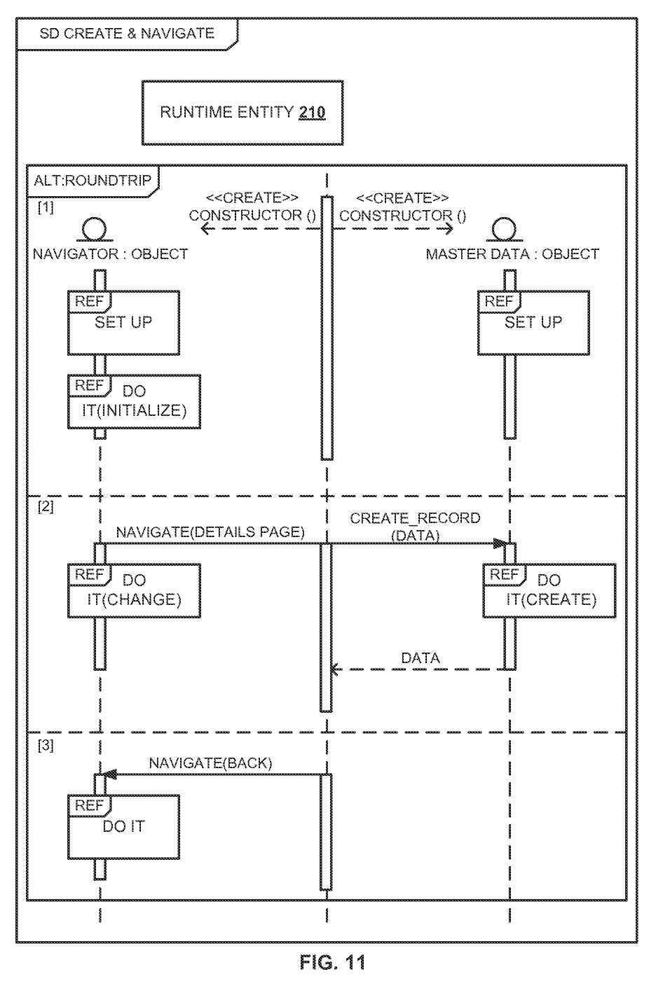

FIG. 11 is a sequence diagram for defining or creating a plurality of objects (stuffs) in a client-server round trip, according to an embodiment. The runtime entity may create (define) more than one object (stuff) in the same client-server round trip (e.g., using a function constructor( )). For example, the runtime entity creates a navigator object (stuff1) and a master data object (stuff2). The master data object (stuff1) is set up (registered) for maintaining master data record and navigator object (stuff2) is set up (registered) for maintaining navigation page. The master data object (stuff1) may be registered as “do1” and the navigator object (stuff2) may be registered as “do2.” A creation of a data record (e.g., through create_record(data)) is a first task occurring to the registered master data object (do1). An “it1” is created or initialize corresponding to “do1” (e.g., through do it(create)). The creation of the data record (i.e., create_record(data)) in the master data object occurs at the same time as navigation (e.g., through navigate(detailspage)) in the navigator (do2). An “it2” is created or initialize corresponding to “do2” (e.g., through do it(change)). Each navigation to another page is a change of navigator object “it2.” When an undo is requested both the tasks of both the “it” (it1 and it2) is to be undone at the same time. The runtime entity reports modifications of their respective “it” (it1 and it2) to the DO_ENGINE 100.

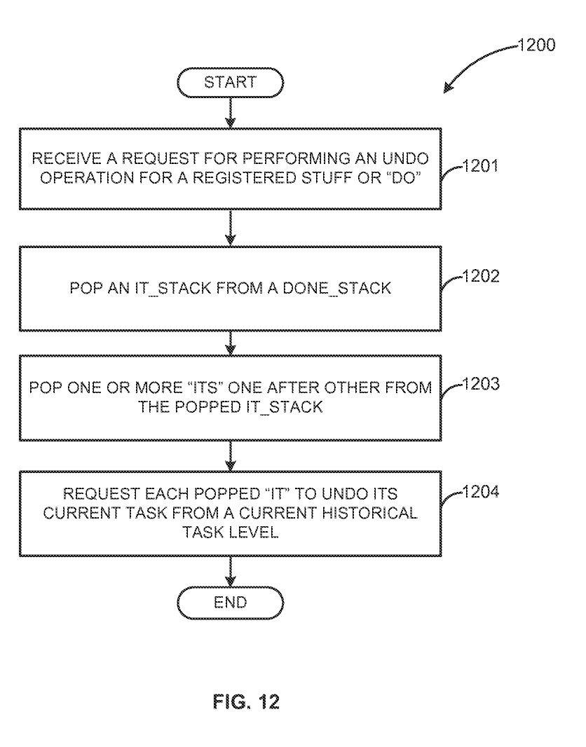

FIG. 12 is a flowchart illustrating process 1200 to perform undo operation relative to a registered stuff or “do.” At 1201, a request for performing the undo operation for the “do” is received. At 1202, an it_stack is popped from a done_stack. At 1203, one or more “its” are popped from the it_stack one after the other. At 1204, each popped “it” is requested to undo its current task from a current historical task level.

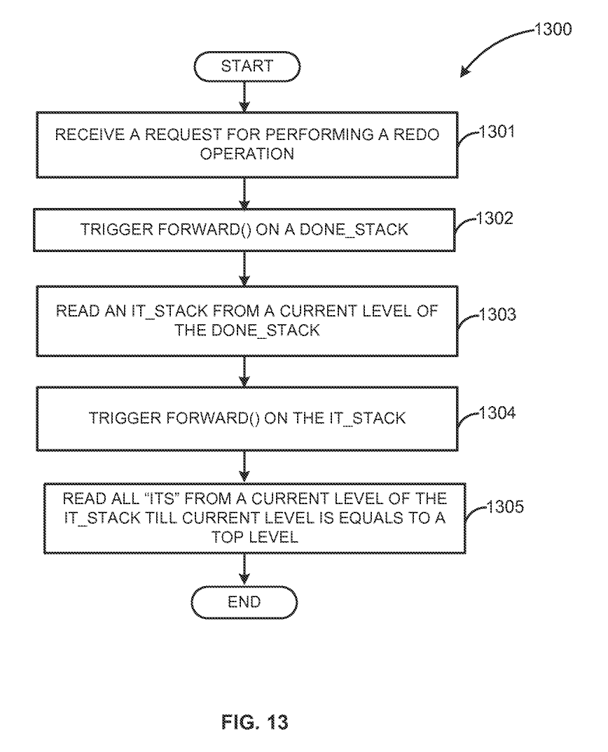

FIG. 13 is a flowchart illustrating process 1300 to perform redo operation relative to “do.” At 1301, a request for performing the redo operation is received. Based upon the request, the done_stack is identified. At 1302, a forward operation is triggered on the done_stack. At 1303, one it_stack is read from a current level of the done_stack. At 1304, the forward operation is triggered on the it_stack. At 1305, all “its” are read from the current level of the it_stack until the current level is equal to a top level. Each “it” is redone by accessing the HOW_TO interface.

Embodiments enable integrating redact functionalities, e.g., undo/redo functionality, within software applications or projects. A product or project can be enhanced or integrated with redact functionalities through an add-on (e.g., DO_ENGINE). Upon integration, the redact functionalities appear within the project. The embodiments also enable performing undo/redo for object change. In various embodiments, creation of an object may include two steps: (i) creation of object itself; and (ii) navigation to an UI to enter data related to the created object. Embodiments enable undoing creation of such object by undoing both the steps (i) and (ii) simultaneously. Therefore, after undoing the creation of the object, an UI from where the creation of the object was triggered is displayed. Further, embodiments provide flexible mechanism where users (e.g., developers) themselves can specify which entities of the project are to be integrated with the DO_ENGINE and how the entities can be integrated.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” includes a single medium or multiple media that stores one or more sets of instructions. The term “computer readable storage medium” includes physical article that is capable of undergoing a set of physical changes to physically store, encode, or otherwise carry a set of instructions for execution by a computer system which causes the computer system to perform the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

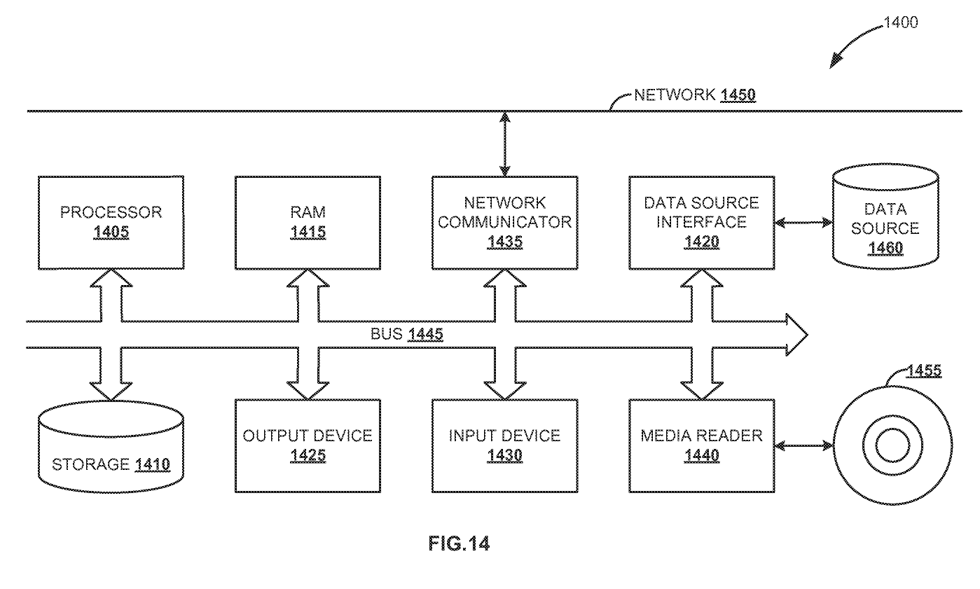

FIG. 14 is a block diagram of an exemplary computer system 1400. The computer system 1400 includes a processor 1405 that executes software instructions or code stored on a computer readable storage medium 1455 to perform the above-illustrated methods. The processor 1405 can include a plurality of cores. The computer system 1400 des a media reader 1440 to read the instructions from the computer readable storage medium 1455 and store the instructions in storage 1410 or in random access memory (RAM) 1415. The storage 1410 provides a large space for keeping static data where at least some instructions could be stored for later execution. According to some embodiments, such as some in-memory computing system embodiments, the RAM 1415 can have sufficient storage capacity to store much of the data required for processing in the RAM 1415 instead of in the storage 1410. In some embodiments, all of the data required for processing may be stored in the RAM 1415. The stored instructions may be further compiled to generate other representations of the instructions and dynamically stored in the RAM 1415. The processor 1405 reads instructions from the RAM 1415 and performs actions as instructed. According to one embodiment, the computer system 1400 further includes an output device 1425 (e.g., a display) to provide at least some of the results of the execution as output including, but not limited to, visual information to users and an input device 1430 to provide a user or another device with means for entering data and/or otherwise interact with the computer system 1400. The output devices 1425 and input devices 1430 could be joined by one or more additional peripherals to further expand the capabilities of the computer system 1400. A network communicator 1435 may be provided to connect the computer system 1400 to a network 1450 and in turn to other devices connected to the network 1450 including other clients, servers, data stores, and interfaces, for instance. The modules of the computer system 1400 are interconnected via a bus 1445. Computer system 1400 includes a data source interface 1420 to access data source 1460. The data source 1460 can be accessed via one or more abstraction layers implemented in hardware or software. For example, the data source 1460 may be accessed by network 1450. In some embodiments the data source 1460 may he accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an enterprise resource planning (ERP) system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments is to be determined by the following claims, which are to be interpreted in accordance with established doctrines of claim construction.

What is claimed is:

1. A non-transitory computer readable storage medium storing instructions, which when executed by a computer cause the computer to perform operations comprising:
receive a request from an entity associated with a project to register a stuff, wherein the stuff comprises a description indicating a purpose of the entity;
based upon the request, register the stuff by:
assigning a unique identifier to the stuff; and
storing the registered stuff along with its unique identifier in a database table:
and
upon registering the stuff, provide an access to at least one artifact selected from a group consisting of:
a work_artifact to trigger redo and undo for the registered stuff based upon user's action and trigger done when a task related to the registered stuff is completed;
a do_artifact to assign one or more information elements to the registered stuff;
an it_artifact communicatively coupled to the do_artifact to perform an operation including one of initialize, create, delete, done, and change corresponding to an information element;
a task_artifact communicatively coupled to the it_artifact to provide at least one of an action and data related to the performed operation; and
a how_artifact communicatively coupled to the it_artifact to handle an undo request and a redo request corresponding to the information element.

2. The computer readable medium of claim 1, wherein the entity is one of a controller, an interface, a navigator, a report, a class, an instance of a class, and a function module.

3. The computer readable medium of claim 1, wherein an artifact comprises at least one of one or more interfaces and one or more classes including one or more functions.

4. The computer readable medium of claim 1, wherein the information element comprises a user interface including information related to the registered stuff.

5. The computer readable medium of claim 1, wherein the it_artifact includes a task_stack to store operations performed on the information element in a last-in first-out (LIFO) format and wherein the task_stack includes at least one of the action and data corresponding to each operation performed on the information element.

6. The computer readable medium of claim 1, wherein the do_artifact includes an it_stack to store information elements on which operation is performed in a last-in first-out (LIFO) format and wherein when a done is triggered by the entity, the it_stack is pushed to a done_stack.

7. The computer readable medium of claim 6 further comprising instructions, which when executed by the computer cause the computer to perform operations comprising:
receiving a request for performing an undo operation;
based upon the request, popping the it_stack from the done_stack;
from the popped it_stack, popping one or more “its” one by one; and
requesting each popped “it” to undo its current task from a current historical task level.

8. The computer readable medium of claim 7 further comprising instructions, which when executed by the computer cause the computer to perform operations comprising:
receiving a request for performing a redo operation;
based upon the request, triggering the forward operation on the done_stack;
reading the it_stack from a current level of the done_stack;
triggering the forward operation on the it_stack; and
reading one or more “its” from the it_stack from current level until the current level is equal to the top level.

9. The computer readable medium of claim 1, wherein the entity request to register the stuff by calling a function of a central class of the do_artifact.

10. The computer readable medium of claim 1, wherein the entity access the work_artifact by calling a function of a central class of the do_artifact.

11. A computer-implemented method for performing an undo operation for a registered stuff including one or more information elements, the method comprising:
receiving a request for performing an undo operation;
based upon the request, popping an it_stack from a done_stack;
from the popped it_stack, popping one or more “its” one by one; and
requesting each popped “it” to undo its current task from a current historical task level.

12. The computer-implemented method of claim 11 further comprising:
receiving a request for performing a redo operation;
based upon the request, triggerring the forward operation on the done_stack;
reading the it stack from a current level of the done_stack;
triggering the forward operation on the it_stack; and
reading one or more “its” from the it_stack from current level until c current level is equal to the top level.

13. A computer system for integrating redact functionalities in application development comprising:
at least one memory to More executable instructions; and
at least one processor communicatively coupled to the at least one memory, the at least one processor configured to execute the executable instructions to:
receive a request from an entity associated with a project to register a stuff,
wherein the stuff comprises a description indicating a purpose of the entity;
based upon the request, register the stuff by:
assigning a unique identifier to the stuff; and
storing the registered stuff along with its unique identifier in a database table;
and
upon registering the stuff, provide an access to at east one artifact selected from a group consisting of:
a work_artifact to trigger redo and undo for the registered stuff based upon user's action and trigger done when a task related to the registered stuff is completed;
a do_artifact to assign one or more information elements to the registered stuff;
an it_artifact communicatively coupled to the do_artifact to perform an operation including one of initialize, create, delete, done, and change corresponding to an information element;
a task_artifact communicatively coupled to the it_artifact to provide at least one of an action and data related to the performed operation; and
a how_artifact communicatively coupled to the it_artifact to handle an undo request and a redo request corresponding to the information element.

14. The computer system of claim 13, wherein the entity is one of a controller, an interface, a navigator, a report, a class, an instance of a class, and a function module.

15. The computer system of claim 13, wherein an artifact comprises at least one of one or more interfaces and one or more classes including one or more functions.

16. The computer system of claim 13, wherein the information element comprises a user interface including information related to the registered stuff.

17. The computer system of claim 13, wherein the it_artifact includes a task_stack to store operations performed on the information element in a last-in first-out (LIFO) format and wherein the task_stack includes at least one of the action and data corresponding to each operation performed on the information element.

18. The computer system of claim 13, wherein the do_artifact includes an it_stack to store information elements on which operation is performed in a last-in first-out (LIFO) format and wherein when a done is triggered by the entity, the it_stack is pushed to a done_stack.

19. The computer system of claim 18, wherein the at least one processor is further configured to execute the executable instructions to:
receive a request for performing an undo operation;
based upon the request, pop the it_stack from the done_stack;
from the popped it_stack, pop one or more “its” one by one; and
request each popped “it” to undo its current task from a current historical task level.

20. The computer system of claim 19, wherein the at least one processor is further configured to execute the executable instructions to:
receive a request for performing a redo operation;
based upon the request, trigger the forward operation on the done_stack;
read the it_stack from a current level of the done_stack;
trigger the forward operation on the it_stack; and
read one or more “its” from the it_stack from current level until the current level is equal to the top level.
